(19) United States
(12) Patent Application Publication
(10) Pub. No.: US 2024/0381336 A1
(43) Pub. Date: Nov. 14, 2024

(54) SYSTEM AND METHOD FOR MULTIPATH TRANSMISSION WITH EFFICIENT ADJUSTABLE RELIABILITY

(71) Applicant: Deutsche Telekom AG, Bonn (DE)

(72) Inventors: Markus Amend, Nidda (DE); Eckard Bogenfeld, Carlsberg (DE); Anna Brunstrom, Karlstad (SE); Marcus Pieska, Karlstad (SE); Andreas Kassler, Karlstad (SE)

(21) Appl. No.: 18/554,799

(22) PCT Filed: Mar. 29, 2022
(86) PCT No.: PCT/EP2022/058277

§ 371 Date: Oct. 11, 2023

(30) Foreign Application Priority Data
Apr. 14, 2021 (EP) 21168248.9

(51) Int. Cl. H04W 72/12; H04L 1/08; H04L 5/00

(52) U.S. Cl. CPC H04W 72/12; H04L 1/08; H04L 5/0053

(57) ABSTRACT

A method and a system including a transmitting device and a receiving device. The transmitting device includes a multipath traffic scheduler and the receiving device includes a reordering module. The multipath traffic scheduler is configured to schedule packets for transmission over at least two paths, each transmitted packet including a sequence identifier. The reordering module is configured to receive packets through the at least two paths, and reorder the received packets sequentially based on the sequence identifier. The multipath traffic scheduler comprises a send-buffer configured to temporarily store the transmitted packets for a predetermined amount of time, and the transmitting device is configured resend a transmitted packet not being received by the receiving device. The transmitting device is configured to adjust a number of allowed re-transmissions or adjust a dimension of the send-buffer for adjusting transmission reliability of the system.

### CROSS REFERENCE TO RELATED APPLICATIONS

This application is a U.S. National Phase application under 35 U.S.C. § 371 of International Application No. PCT/EP2022/058277, filed on Mar. 29, 2022, and claims benefit to European Patent Application No. EP 21168248.9, filed on Apr. 14, 2021. The International Application was published in English on Oct. 20, 2022 as WO 2022/218692 A1 under PCT Article 21(2).

### FIELD

The invention relates to a method and system comprising a transmitting device and a receiving device, the transmitting device comprises a multipath traffic scheduler and the receiving device comprises a reordering module, as defined in the independent claims.

### BACKGROUND

Multipath network protocols such as MPTCP [1], MP-DCCP [3] or MP-QUIC [2] allow to establish more than one communication flow between a sender and a receiver. FIG. 1 shows a sender, i.e. a transmitting device, and a receiver (receiving device). Multiple paths 1 to n are established between the sender and the receiver. A generator generates data packets 1 to 15 that pass a sequencing module which assigns each packet a respective sequence number. The sequenced data packets are passed to a scheduler which schedules the data packets to the multiple paths of a multipath channel. The data packets ordered in sequence 12, 13, 14 are transmitted over the multipath channel and are queued in a reorder queue at the receiver side where they arrive at an input of the reorder queue. In the reorder queue the data packets are reordered and reordered data packets (such as 1, 2, 3) are provided at an output to the receiver.

On sender side that gives the ability to decide how to schedule the traffic across these communication paths 1-n depicted in FIG. 1. An efficient scheduling is relied on a proper path estimation, which characterizes the transport capabilities of the communication paths like available bandwidth or Round-Trip-Time. Using [1]-[3], will gain these values from the employed congestion control approach like New Reno, Cubic, BBR etc.

While on sender side traffic is split across communication paths, the receiver side usually has to take care to re-assemble the formerly split traffic and reconstruct the order of sequence. Out-of-order delivery occurs at the receiver due to communication flows with distinct transport characteristics of latency, error rate and bandwidth. In order to reconstruct the order of sequence a re-order queue is used to compensate for those varying transport characteristics. A possibly entity therefore is described in [4].

With the increasing number of used communication flows in a multipath system the probability for packet loss might be higher than the one over single path and impact the E2E performance from services carried over the multipath system. Independent from that, the reconstruction of the packet sequence at the multipath receiver side undergoes a challenge each time it has to deal with lost information.

This becomes mainly an issue for multipath architectures, which are based on unreliable network protocols as depicted in FIG. 2. This one relies on MP-DCCP for multipath transmission of an E2E service between Client and Server. The Virtual Network Interface will ensure the E2E service communication over multiple paths by forwarding the traffic over the MP-DCCP system. That is, any information routed/send through the VNIF will be dispatched to the MP-DCCP system where it becomes encapsulated and scheduled across the DCCP communication paths. On the MP-DCCP receiver side the encapsulated information passes a reordering process and the original information-after removing the encapsulation overhead-exits the VNIF to become forwarded to the original destination. Two communication flows “DSL” and “LTE” are assumed here, as depicted in FIG. 2. Per se, lost packets are not re-transmitted due to the unreliable nature of DCCP.

A similar framework employing the QUIC protocol [9] is implementable using the MP-QUIC [2] instead of MP-DCCP, the work at QUIC MASQUE [7] for encapsulation (VNIF) and QUIC DATAGRAM [8] for unreliable transmission—the nature of DCCP.

Selecting MPTCP [1] or [5] as multipath network protocol would solve the demand on strict reliability since that is an integral part of the underlying TCP. However, it let not select the degree of reliability.

As of today, and according to the above description, only multipath architectures with multipath network protocols are known which let select strict reliability or no reliability at all. Transitional solutions and dynamic adjustments are not foreseen. E2E services which may profit from a loss recovery within the multipath system, but in a less restrictive way than it is with [1] or [5], cannot benefit at all.

### SUMMARY

In an embodiment, the present disclosure provides a system comprising a transmitting device and a receiving device. The transmitting device comprises a multipath traffic scheduler and the receiving device comprises a reordering module, wherein: the multipath traffic scheduler is configured to schedule packets for transmission over at least two paths, each transmitted packet comprising a sequence identifier, the reordering module is configured to receive packets through the at least two paths, and reorder the received packets sequentially based on the sequence identifier, wherein the multipath traffic scheduler comprises a send-buffer configured to temporarily store the transmitted packets for a configurable amount of time, and the transmitting device is configured to resend a transmitted packet not being received by the receiving device, wherein the transmitting device is configured to adjust a number of allowed re-transmissions or adjust a dimension of the send-buffer for adjusting transmission reliability of the system.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 depicts communication paths between a sender and a receiver, in accordance with an embodiment of the present invention.

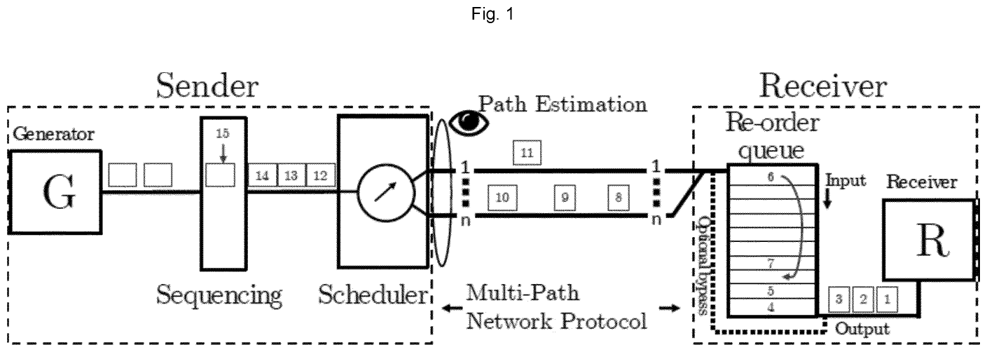

FIG. 2 depicts a multipath setup, in accordance with an embodiment of the present invention.

### DETAILED DESCRIPTION

In accordance with an embodiment, the present invention provides a concept for solving the above-mentioned problem when transmitting data packets over a multipath channel. In accordance with another embodiment, the present invention introduces a concept for an efficient and partial reliable reordering for packet transmission in multipath scenarios which is not based on strict reliability.

According to a first aspect, the invention provides a system comprising a transmitting device and a receiving device, the transmitting device comprises a multipath traffic scheduler and the receiving device comprises a reordering module. The multipath traffic scheduler is configured to schedule packets for transmission over at least two paths, and each transmitted packet comprises a sequence identifier. The reordering module is configured to receive packets through the two or more paths, and to reorder the received packets sequentially based on the sequence identifier. The multipath traffic scheduler comprises a send-buffer configured to temporarily store the transmitted packets for a configurable amount of time. The transmitting device is configured to resend a transmitted packet not being received by the receiving device. The transmitting device is configured to adjust a number of allowed re-transmissions or adjust the dimension of the send-buffer for adjusting transmission reliability of the system.

In some embodiments, transmission over at least two paths is performed through a tunnel connection using a Virtual Network Interface, VNI.

The send-buffer is a path individual send-buffer for each of the two or more paths.

In some embodiments, each path individual send-buffer is configured to temporarily store the transmitted packets, through its respective path, for a predetermined amount of time.

The reordering module is further configured to send an acknowledgment to the transmitting device, if a packet is received successfully.

In some embodiments, the reordering module is further configured to send a negative-acknowledgment to the transmitting device, if a packet is detected outstanding.

In some embodiments, the transmitting device is further configured to receive the acknowledgement and/or negative-acknowledgement sent by the receiving device, and to delete the acknowledged received packet from the send-buffer.

According to an embodiment, if no acknowledgement and/or negative-acknowledgement is received for one or more transmitted packets, the transmitting device is configured to check whether the non-acknowledged one or more transmitted packets are stored in the send-buffer, and to resend each stored non-acknowledged transmitted packet at a configurable time.

The receiving device is further configured to initiate by the reordering module a resend-request to the transmitting device based on a monitoring of sequence identifiers received.

The transmitting device is configured to anticipate a packet retransmission from the send buffer. In some embodiments, the transmitting device is configured to anticipate a packet retransmission from the send buffer based on cross layer information and/or outstanding acknowledgements.

The multipath traffic scheduler further comprises an interface for external adjustment of the transmission reliability of the system.

The reordering module is configured to perform adjustable packet loss detection by using latency information such as Round-Trip Time, RTT, or one-way-latency.

According to a further embodiment, the time how long packets are kept in the send-buffer is statically or dynamically determined by receipt of acknowledgment, ACK, information and/or negative-acknowledgement, NACK, information and/or BDP dependent and/or based on a static value and/or buffer level dependent and/or latency dependent.

According to a further embodiment, the multipath-traffic scheduler is configured to re-send packets over a path different to the original path.

According to a further embodiment, the multipath-traffic scheduler is combined with one of the multipath protocols MP-DCCP, MP-QUIC, SCTP.

According to a second aspect, the invention provides a method of multi-path transmission of packets in a communication system from a transmitting device to a receiving device, the transmitting device comprising a multipath traffic scheduler and the receiving device comprising a reordering module, the method comprising:
scheduling packets, by the multipath traffic scheduler, for transmission over at least two paths, each transmitted packet comprising a sequence identifier,
temporarily storing the transmitted packets at the multipath traffic scheduler in a send-buffer for a configurable amount of time;
receiving, by the reordering module, packets through the two or more paths, and reordering the received packets sequentially based on the sequence identifier,
resending, by the transmitting device, a transmitted packet not being received by the receiving device,
wherein the transmitting device is configured to adjust a number of allowed re-transmissions or adjust the dimension of the send-buffer for adjusting transmission reliability of the system.

In some embodiments, the send-buffer is a path individual send-buffer for each of the two or more paths.

In some embodiments, each path individual send-buffer is configured to temporarily store the transmitted packets, through its respective path, for a predetermined amount of time.

According to a further embodiment, the multipath-traffic scheduler re-sends packets over a path different to the original path.

In some embodiments, the method further comprises initiating by the reordering module a resend-request to the transmitting device based a monitoring of sequence identifiers received.

The reordering module is further configured to send an acknowledgment to the transmitting device, if a packet is received successfully.

In some embodiments, the reordering module is further configured to send a negative-acknowledgement to the transmitting device, if a packet is detected outstanding.

In some embodiments, the transmitting device is further configured to receive the acknowledgement and/or negative-acknowledgement sent by the receiving device, and to delete the acknowledged received packet from the send-buffer.

According to an embodiment, if no acknowledgement and/or negative-acknowledgement is received for one or more transmitted packets, the transmitting device is configured to check whether the non-acknowledged one or more transmitted packets are stored in the send-buffer, and to resend each stored non-acknowledged transmitted packet at a configurable time.

The transmitting device is configured to anticipate a packet retransmission from the send buffer. In some embodiments, the transmitting device is configured to anticipate a packet retransmission from the send buffer based on cross layer information and/or outstanding acknowledgements.

The multipath traffic scheduler further comprises an interface for external adjustment of the transmission reliability of the system.

The reordering module is configured to perform adjustable packet loss detection by using latency information such as Round-Trip Time, RTT, or one-way-latency.

According to a further embodiment, the time how long packets are kept in the send-buffer is statically or dynamically determined by receipt of acknowledgement, ACK, information and/or negative-acknowledgement, NACK, information and/or BDP dependent and/or based on a static value and/or buffer level dependent and/or latency dependent.

According to a further embodiment, the multipath-traffic scheduler is combined with one of the multipath protocols MP-DCCP, MP-QUIC, SCTP.

The methods and systems presented below may be of various types. The individual elements described may be realized by hardware or software components, for example electronic components that can be manufactured by various technologies and include, for example, semiconductor chips, ASICs, microprocessors, digital signal processors, integrated electrical circuits, electro-optical circuits and/or passive components

The devices, systems and methods presented below are capable of transmitting information over a communication network. The term communication network refers to the technical infrastructure on which the transmission of signals takes place. The communication network essentially comprises the switching network in which the transmission and switching of the signals takes place between the stationary devices and platforms of the mobile radio network or fixed network, and the access network in which the transmission of the signals takes place between a network access device and the communication terminal. The communication network can comprise both components of a mobile radio network as well as components of a fixed network. In the mobile network, the access network is also referred to as an air interface and includes, for example, a base station (NodeB, eNodeB, radio cell) with mobile antenna to establish the communication to a communication terminal as described above, for example, a mobile phone or a mobile device with mobile adapter or a machine terminal. In the fixed network, the access network includes, for example, a DSLAM (digital subscriber line access multiplexer) to connect the communication terminals of multiple participants based on wires. Via the switching network the communication can be transferred to other networks, for example other network operators, e.g. foreign networks.

In communications and computing systems, the Open Systems Interconnection model (OSI model) defines a conceptual model that characterizes and standardizes the communication functions without regard to its underlying internal structure and technology. Its goal is the interoperability of diverse communication systems with standard protocols. The model partitions a communication system into abstraction layers. The original version of the model defined seven layers: Physical layer (Layer 1), Data Link layer (Layer 2), Network layer (Layer 3), Transport layer (Layer 4), Session layer (Layer 5), Presentation layer (Layer 6) and Application layer (Layer 7).

The invention provides for an adjustable recovery of lost information in a multipath system which is not based on strict reliability like MPTCP. The proposed solution consists at least of a multipath traffic scheduler and a re-order module. It includes the functions of a multipath scheduler with a send buffer for reliability, a tunable degree of re-transmission at the scheduler using parameter x={0 (unreliable)≤x≤∞ (reliable)} specifying e.g. the number of re-transmissions.

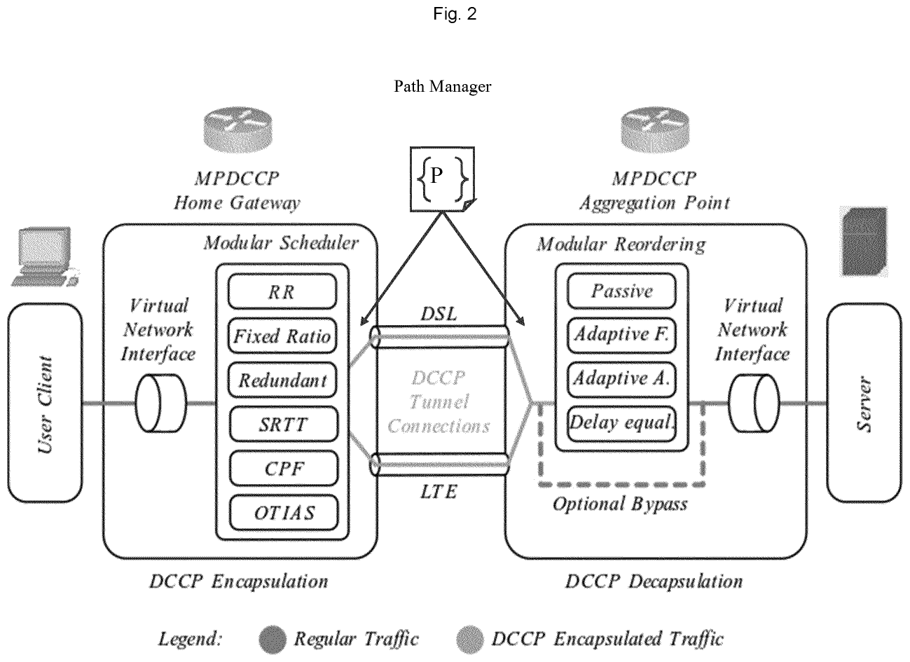

The present invention provides the benefit that especially in multipath setups like the one shown in FIG. 2, when the multipath transport has shorter latencies than the E2E service, re-transmission is a valuable approach to overcome the impact of packet loss. However, to keep a benefit, an aspect of the invention considers the number of re-transmissions. This intends to avoid a negative reaction of the E2E service like it would be without the present invention.

The present invention has an impact to such multipath systems which are based on multipath network protocols without inherent strict reliability. MPTCP is a protocol that has strict reliability inherited from TCP. Strict reliability ensures that a receiver get hands on exactly the same data stream as originated from the sender. No loss, out-of-order, bit errors are allowed. Since this cannot be weakened without fundamentally changing the TCP protocol, which is not intended by the present invention, the present invention focus on multipath network protocols without strict reliability. For this it is independent if unreliable transmissions are part of the original defined standard (e.g. a IETF RFC), an extension or a self-modified/created protocol.

In an implementation of the invention, MP-DCCP is used as the protocol of choice. By design, DCCP and also the MP-DCCP does not include any reliability, which means it is not ensured in any way that send messages will arrive. However, due to the fact that sent information is acknowledged, the (MP-) DCCP sender is aware about the receive status. That information is used according to the present invention to provide a scheduler with multiple degrees of reliability. Conjunct with that it may require a send buffer, which keeps the already sent information for potential re-transmission. The send buffer is path individual and/or an overall one. Furthermore, the send buffer is already provided along with the selected protocol and/or implementation. Whenever the sender side becomes aware of any outstanding and potentially lost information, the scheduler can decide to resend this information over the same or a subsequent path. In that case the sender has to ensure that the information can be identified on receiver side which information is contained in this re-send information. A re-send is only possible when the concerning information is still buffered. It is up to the implementation how long data is kept in the send buffer(s). Multiple options exist, e.g. as long as data is acknowledged (resembles TCP), BDP dependent, fixed time, fixed volume, latency dependent or other possibilities.

Furthermore, it is up to the scheduler how often identified data will be retransmitted. For example, only once, as long as it is received. In some embodiments, this is also a question of latency or a latency ratio between paths. So both, the dimension of the send buffer(s) as well as the number of re-transmissions, allow the sender to fine tune the degree of reliability, according to an aspect of the invention.

Other multipath protocols, which can be designed in similar ways, are QUIC [9] combined with the DATAGRAM [8] extension, MP-QUIC [2] combined with the DATAGRAM [8] extension, SCTP combined with PR-SCTP or CMT-SCTP with PR-SCTP [11]. All the aforementioned protocols use specific receiver to sender acknowledgement, which is exploited for the present invention as it lets the sender know if an information is received. In the case of PR-SCTP, the degree of reliability can be controlled instructing this extension as such.

An alternative embodiment of the invention without requiring a feedback loop like the protocols above—send data and acknowledge them—is the active request from receiver side or anticipating on sender side re-transmission. The first, i.e., the active request from receiver side is triggered by the re-order module on receiver side, e.g. by sending a NACK (negative acknowledgement) based on monitoring sequence numbers or latency based. On the other hand, anticipation on sender side uses cross layer information to assume a packet loss or bit errors.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

Furthermore, in the claims the word “comprising” does not exclude other elements or steps, and the indefinite article “a” or “an” does not exclude a plurality. A single unit may fulfil the functions of several features recited in the claims. The terms “essentially”, “about”, “approximately” and the like in connection with an attribute or a value particularly also define exactly the attribute or exactly the value, respectively. Any reference signs in the claims should not be construed as limiting the scope.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCES

[1] A. Ford and C. Raiciu and M. Handley and O. Bonaventure, “TCP Extensions for Multipath Operation with Multiple Addresses”, RFC no. 6824 January 2013
[2] Quentin Coninck and Olivier Bonaventure, “Multipath Extensions for QUIC (MP-QUIC)”, draft-deconinck-quic-multipath-05, August 2020
[3] Markus Amend and Anna Brunstrom and Andreas Kassler and Veselin Rakocevic, “DCCP Extensions for Multipath Operation with Multiple Addresses”, draft-amend-tsvwg-multipath-dccp-03, November 2019
[4] Patent “Techniques for efficient reordering of data packets in multipath scenarios”, EP3531637B1, Inventors: Markus Amend and Eckard Bogenfeld
[5] Zhang, Wentao & Wu, Qian & Yang, Wang & Li, Hewu. (2010). Reliable Multipath Transfer Scheduling Algorithm Research and Prototype Implementation. Proceedings of the Asia Pacific Advanced etwork. 30. 10.7125/APAN.30.7.
[6] Markus Amend and Eckard Bogenfeld and Anna Brunstrom and Andreas Kassler and Veselin Rakocevic, “A multipath framework for UDP traffic over heterogeneous access networks”, draft-amend-tsvwg-multipath-framework-mpdccp-01, January 2020
[7] https://datatracker.ietf.org/wg/masque/about/[8]
[8] T. Pauly and E. Kinnear and D. Schinazi, “An Unreliable Datagram Extension to QUIC”, draft-pauly-quic-datagram-05, November 2019
[9] J. Iyengar and M. Thomson, “QUIC: A UDP-Based Multiplexed and Secure Transport”, draft-ietf-quic-transport-32, 20 Oct. 2020
[10] R. Stewart, “Stream Control Transmission Protocol”, RFC no. 4960 September 2007
[11] Michael A. Ramalho and Qiaobing Xie and Randall R. Stewart and Michael Tüxen and Phillip Conrad, “Stream Control Transmission Protocol (SCTP) Partial Reliability Extension”, RFC no. 3758 May 2004
[12] Professor Paul D. Amer and Martin Becke and Thomas Dreibholz and Nasif Ekiz and Jana Iyengar and Preethi Natarajan and Randall R. Stewart and Michael Tüxen, “Load Sharing for the Stream Control Transmission Protocol (SCTP)”, draft-tuexen-tsvwg-sctp-multipath-20, 28 Jul. 2020.

1. A system comprising:
a transmitting device and a receiving device, wherein the transmitting device comprises a multipath traffic scheduler and the receiving device comprises a reordering module, wherein:
the multipath traffic scheduler is configured to schedule packets for transmission over at least two paths, each transmitted packet comprising a sequence identifier,
the reordering module is configured to receive packets through the at least two paths, and reorder the received packets sequentially based on the sequence identifier, wherein the multipath traffic scheduler comprises a send-buffer configured to temporarily store the transmitted packets for a configurable amount of time, and
the transmitting device is configured to resend a transmitted packet not being received by the receiving device, wherein the transmitting device is configured to adjust a number of allowed re-transmissions or adjust a dimension of the send-buffer for adjusting transmission reliability of the system.

2. The system of claim 1, wherein transmission over the at least two paths is performed through a tunnel connection using a Virtual Network Interface (VNI).

3. The system of claim 1, wherein the send-buffer is a path individual send-buffer for each of the at least two, and each path individual send-buffer is configured to temporarily store the transmitted packets, through its respective path, for a predetermined amount of time.

4. The system of claim 1, wherein
the reordering module is further configured to send an acknowledgment and/or negative-acknowledgment to the transmitting device, based on determining whether a packet is received successfully and/or detected outstanding; and
the transmitting device is further configured to receive the acknowledgement and/or negative-acknowledgement sent by the receiving device, and to delete the acknowledged received packet from the send-buffer.

5. The system of claim 4, wherein, based on determining that no acknowledgement and/or negative-acknowledgement is received for one or more transmitted packets, the transmitting device is configured to check whether the non-acknowledged one or more transmitted packets are stored in the send-buffer, and to resend each stored non-acknowledged transmitted packet at a configurable time.

6. The system of claim 1, wherein the receiving device is configured to initiate by the reordering module a resend-request to the transmitting device based on a monitoring of sequence identifiers received.

7. The system of claim 1, wherein the transmitting device is configured to anticipate a packet retransmission from the send-buffer.

8. The system of claim 7, wherein the transmitting device is configured to anticipate the packet retransmission from the send-buffer based on cross layer information.

9. The system of claim 7, wherein the transmitting device is configured to anticipate the packet retransmission from the send-buffer based on cross layer information and outstanding acknowledgements.

10. The system of claim 7, wherein the transmitting device is configured to anticipate the packet retransmission from the send buffer based on outstanding acknowledgements.

11. The system of claim 1, wherein the multipath traffic scheduler further comprises an interface for external adjustment of the transmission reliability of the system.

12. The system of claim 1, wherein the reordering module is configured to perform adjustable packet loss detection by using latency information such as Round-Trip Time (RTT) or one-way-latency.

13. The system of claim 1, wherein the configurable amount of time is statically or dynamically determined by receipt of acknowledgement (ACK) information and/or negative-acknowledgement (NACK) information and/or BDP dependent and/or based on a static value and/or buffer level dependent and/or latency dependent.

14. The system of claim 1, wherein the multipath-traffic scheduler is configured to re-send packets over a path different to the original path.

15. The system of claim 1, wherein the multipath-traffic scheduler is combined with one of the protocols MP-DCCP, MP-QUIC, UDP, IP-in-IP, GRE Tunnel Bonding.

16. A method of multi-path transmission of packets in a communication system from a transmitting device to a receiving device, wherein the transmitting device comprising a multipath traffic scheduler and the receiving device comprising a reordering module, the method comprising:
scheduling packets, by the multipath traffic scheduler, for transmission over at least two paths, each transmitted packet comprising a sequence identifier,
temporarily storing the transmitted packets at the multipath traffic scheduler in a send-buffer for a configurable amount of time;
receiving, by the reordering module, packets through the at least two paths, and reordering the received packets sequentially based on the sequence identifier, and
resending, by the transmitting device, a transmitted packet not being received by the receiving device,
wherein the transmitting device is configured to adjust a number of allowed re-transmissions or adjust a dimension of the send-buffer for adjusting transmission reliability of the system.

17. The system of claim 16, wherein the send-buffer is a path individual send-buffer for each of the at least two paths, and each path individual send-buffer is configured to temporarily store the transmitted packets, through a respective path, for a predetermined amount of time.

18. The system of claim 16, wherein the multipath-traffic scheduler re-sends packets over a path different to the original path.
